(19) United States
(12) Patent Application Publication
(10) Pub. No.: US 2015/0326019 A1
(43) Pub. Date: Nov. 12, 2015

(54) SOLAR ANTI-SHADOWING CIRCUIT

(71) Applicant: SOYO LINK ENERGY CO., LTD., Taoyuan (TW)

(72) Inventors: Ching-Chuan Wei, Taoyuan (TW); Tien-Tsai Lee, Taoyuan (TW)

(73) Assignee: SOYO LINK ENERGY CO., LTD., Taoyuan (TW)

(21) Appl. No.: 14/484,798

(22) Filed: Sep. 12, 2014

(30) Foreign Application Priority Data
May 7, 2014 (TW) 103116300

(51) Int. Cl. H02J 3/38

(52) U.S. Cl. CPC H02J 3/383

(57) ABSTRACT

A solar anti-shadowing circuit coupled to multiple solar cell units connected in series. The circuit includes a metal oxide semiconductor (MOS) switching group. The switching group includes multiple MOS switches, and each of switches is connected to the corresponding solar cell unit in parallel. The circuit also includes a driving unit group, and the driving unit group includes multiple driving units. Each of the multiple driving units respectively outputs a control signal to the corresponding switch. When a shadowing event happen, the driving unit outputs the control signal to the corresponding MOS switch so as to electrically connect the MOS switch.

### BACKGROUND OF THE INVENTION

1. Field of the Invention

The present invention relates to a solar circuit, and more particularly to a solar anti-shadowing circuit.

2. Description of Related Art

The solar power is now widely used as one of the methods to generate the alternative energy. The power generation method of the solar power is more environmentally friendly comparing to the conventional power generation methods (for example: thermal power or water power). However, the service life of the solar panels and solar power module is affected by many factors, which significantly affect the stability of the solar power.

In general, one of the factors affecting the service life of the solar panels and solar module is the shadowing effect. When a solar cell used for converting the solar power to the electricity occur the shadowing effect, the internal resistance of the solar cell which is shadowed is high so as to generate the heat. By the heating time is increased, the failure probability of the solar cell is increased. As a result, the power obtaining rate is decreased. To solve the above problem, in the prior art, a diode is usually used for protecting the solar cell. When the shadowing effect is happen, the diode can prevent a reverse current from flowing into the solar cell in order to protect the solar cell from being burned.

However, the diode may be damaged because of the bad heat dissipation at high temperature when conduction and flowing large amount of current. Therefore, the diode cannot protect the solar cell so as to affect the operation of the solar panel and solar module. Even the diode is not damaged, in a high temperature operation, the diode cause high power loss, and the power generation efficiency of the solar panel and the solar module is poor. As a result, how to improve the above problems to make solar power more popular is an urgent issue need to be resolved by the industry.

### SUMMARY OF THE INVENTION

The technical problem solved by the present invention is that providing a solar anti-shadowing circuit to improve the operation of the solar cell unit surfer the shadowing event. The present invention utilizes the electric switches (for example: diode and PMOS) to determine the shadowing effect according to the voltages generated by the solar cell units and to bypass the solar cell unit encounter the shadowing effect such that the entire solar power generation module can operate normally. The present invention also provides an overheated protection unit so as to protect the electric switches from being burned because the environment temperature is too high. The present invention also provides a release unit. When the shadowing event and the overheated condition are removed, the release unit can release the solar cell unit which is bypassed before to work normally. If the release unit does not exist, and even the shadowing event is removed, the MOS switches which have been electrically connected cannot be disabled. Therefore, the power generated by the solar power generation module is maximized through the release unit of the present invention.

To solve the aforementioned technical problem, an embodiment of the present invention provides a solar anti-shadowing circuit coupled to multiple solar cell units connected in series comprising: a metals oxide semiconductor (MOS) switching group including multiple MOS switches, and each of the MOS switches is coupled to a corresponding solar cell unit; and a driving unit group including multiple driving units, and each of the multiple driving units respectively outputs a control signal to the corresponding MOS switch for controlling the MOS switch; wherein, when a shadowing event is occurred, the multiple driving units output the control signals to the corresponding MOS switches so as to electrically connect the MOS switches.

The present invention further comprises an oscillator coupled to the switching unit group and the driving unit group through a bus to timely output a release signal, wherein, when the shadowing event is removed, the release signal outputted by the oscillator electrically disconnects the corresponding MOS switch.

The present invention further comprises an overheated protection unit coupled to the switching unit group and the driving unit group through a bus; when an overheated condition is occurred, the overheated protection unit outputs an overheated signal to electrically connect the switch which is overheated.

### BRIEF DESCRIPTION OF THE DRAWINGS

FIG. 1 is a schematic of a solar anti-shadowing circuit according to an embodiment of the present invention.

### DETAILED DESCRIPTION OF THE PREFERRED EMBODIMENT

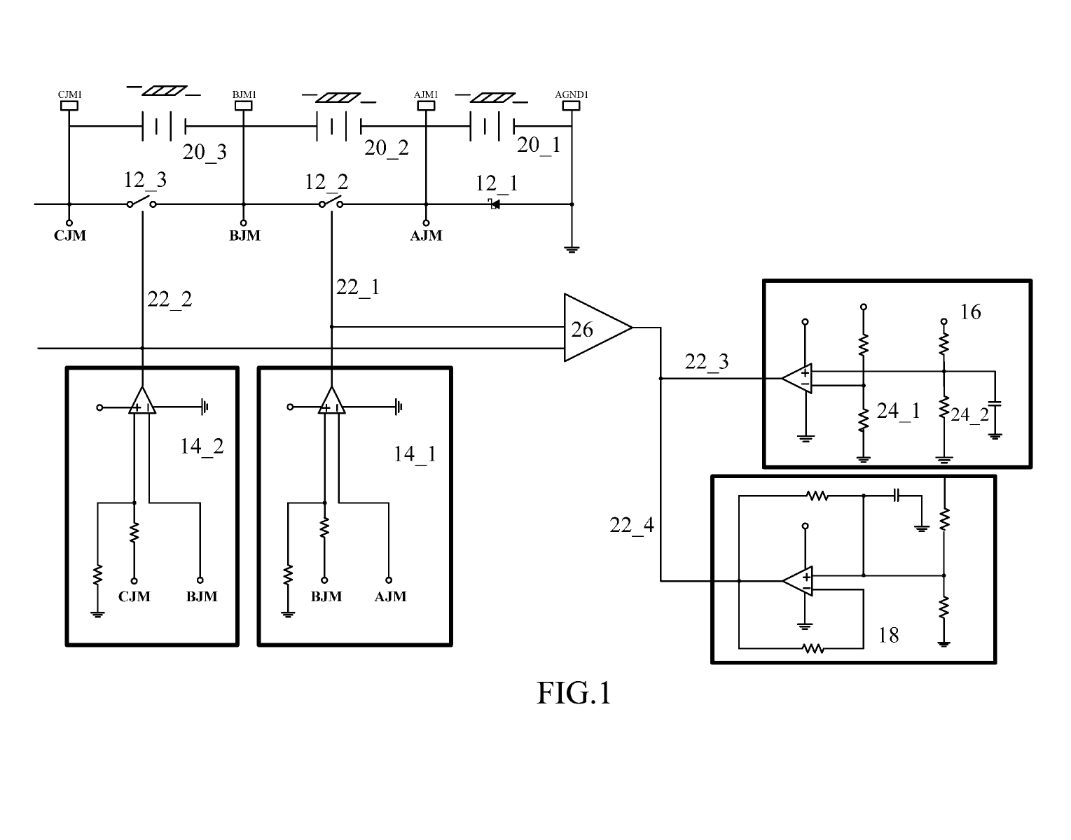

Preferred embodiments are described below with reference to the drawings. FIG. 1 is a schematic of a solar anti-shadowing circuit according to an embodiment of the present invention. As shown FIG. 1, the solar anti-shadowing circuit includes a switching group having multiple switches 12_1, 12_2, 12_3; a driving unit group having multiple driving units 14_1 and 14_2 for controlling the multiple switches 12_1, 12_2, and 12_3; an overheated protection unit 16; an oscillator 18; and a bus 26. The multiple switches 12_1, 12_2, 12_3 are connected to corresponding solar cell units 20_1, 20_2, and 20_3 for providing bypass paths to bypass the solar cell units 20_1, 20_2, and 20_3.

In one embodiment, the solar cell units 20_1, 20_2, and 20_3 respectively connect to the switches 12_1, 12_2, and 12_3. The person skilled in the art can understand that the number of the solar cell units is not limited to three (that is, 20_1, 20_2, and 20_3). The number of the solar cell units can be adjusted according to the size of the solar power generation module. In one embodiment, the solar cell units 20_1, 20_2, and 20_3 are connected in series. The switch 12_1 is connected in parallel with the solar cell unit 20_1. In the same way, the switch 12_2 is connected in parallel with the solar cell unit 20_2, and the switch 12_3 is connected in parallel with the solar cell unit 20_3.

In one embodiment, the switches 12_1, 12_2, and 12_3 are semiconductor switches. For example, the switch 12_1 is a diode, and the switches 12_2 and 12_3 are metal oxide semiconductors (MOS), but the present invention is not limited thereto. The switches 12_1, 12_2, and 12_3 can be adjusted according to the requirement. In one embodiment, the switches 12_2 and 12_3 are P-channel metal oxide semiconductors (PMOS). An anode of the switch 12_1 is coupled to a ground, and a cathode of the switch 12_1 is coupled to a drain electrode of the switch 12_2. A source electrode of the switch 12_2 is coupled to a drain electrode of the switch 12_3 and so on. However, the present invention is not limited thereto. The connection type and relationship of the switches 12_1, 12_2, and 12_3 can be adjusted according to the requirement.

As shown in FIG. 1, the driving unit group includes a first driving unit 14_1 and a second driving unit 14_2. The first driving unit 14_1 and the second driving unit 14_2 can control the conduction of switches 12_2 and 12_3. The person skilled in the art can understand that the number of the driving units is decided according to the number of the switches. The present embodiment is merely illustrative. The first driving unit 14_1 and the second driving unit 14_2 respectively output control signals 22_1 and 22_2 to a gate electrode of the switch 12_2 and a gate electrode of the switch 12_3 in order to control the conduction (turn on or electrically connect) of the switches 12_2 and 12_3. In one embodiment, the first driving unit 14_1 and the second driving unit 14_2 can be operational amplifiers (the present invention is not limited to) to compare that if voltage of the adjacent solar cell units is balance so as to determine if electrically connecting the switches 12_2 and 12_3.

When the solar anti-shadowing circuit is working and no shadowing event occurs, the solar panels receive the solar power to generate electricity to the solar cell units 20_1, 20_2, and 20_3. At this time, the relationship of the voltages AJM, BJM, and CJM of the solar cell units 20_{—1, 20}_2, and 20_3 is AJM<BJM<CJM. The first driving unit 14_1 and the second driving unit 14_2 have no actions. As a result, the switches 12_2 and 12_3 are electrically disconnected.

When the solar panels encounter the shadowing event, for the convenience of description, the switches 12_2 and 12_3 are PMOS as an example. Assuming that the shadowing event occurred at the solar panel corresponding to the solar cell unit 20_2, the voltage BJM generated by a voltage dividing relationship is decreased. When the voltage BJM is lower than the voltage AJM generated by the solar cell unit 20_1, the first driving unit 14_1 output a control signal 22_1 (such as logic LOW) to drive the switch 12_2 to be electrically connected. Because the conduction of the switch 12_2 forms a bypass path, the solar cell unit 20_2 is bypassed. Similarly, assuming that the shadowing event occurred at the solar panel corresponding to the solar cell unit 20_3, the voltage CJM generated by the solar cell unit 20_3 is decreased. When the voltage CJM is lower than the voltage BJM generated by the solar cell unit 20_2, the second driving unit 14_2 outputs a control signal 22_2 to drive the switch 12_2 to be electrically connected. Because the conduction of the switch 12_3 forms a bypass path, the solar cell unit 20_3 is bypassed.

In another embodiment, the solar anti-shadowing circuit further comprises an overheated protection unit 16. The overheated protection unit 16 utilizes the bus 26 to couple to the first driving unit 14_1 and the second driving unit 14_2. The overheated protection unit 16 utilizes at least one temperature sensor (such as a thermistor) to detect the environmental temperature or the temperature of the switches 12_2 and 12_3 to protect the entire solar power generation module. The present embodiment utilizes two negative temperature coefficient thermistors as an example. In the present embodiment, the temperature sensor 24_1 is used for detecting the surface temperature of the switches 12_2 and 12 3, and the temperature sensor 24_2 is used for detecting the environmental temperature. In one embodiment, the bus 26 is a diode, wherein, an anode of the diode is coupled to the output terminals of the first driving unit 14_1 and the second driving unit 14_2, and a cathode of the diode is coupled to the output terminal of the overheated protection unit 16.

In this embodiment, when the surface temperature of the switches 12_2 and 12_3 is higher than the environmental temperature, the overheated protection unit 16 outputs an overheated signal 22_3 with logic high. The overheated signal 22_3 cannot pass through the bus 26. Therefore, the first driving unit 14_1 and the second driving unit 14_2 can enable the anti-shadowing function. Through determining the voltages AJM, BJM, and CJM of the solar cell units 20_1, 20_2, and 20_3 to decide if electrically connecting the switches 12_2 and 12_3 to form the bypass paths so as to bypass the solar cell units 20_2 and 20_3. The operation principle of the driving units is the same as illustrated foregoing.

As described above, when the switch 12_2 or 12_3 is electrically connected to form the bypass path, the solar cell unit 20_2 or 20_3 stop working so as to maintain the entire solar power generation module working normally. However, when the shadowing event is disappeared (for example, the shadow object is removed from the solar panels) and if the solar cell units 20_2 or 20_3 is still bypassing, the power generation efficiency of the solar power generation module is greatly decreased.

Therefore, in another embodiment, the solar anti-shadowing circuit further comprises an oscillator 18. The oscillator 18 couples to the gate electrode of the switch 12_2 and the gate electrode of the switch 12_3 through a pull high resistor (for example: 1 mega ohm). The oscillator 18 also couples to the output terminals of the first driving unit 14_1 and the second driving unit 14_2. The oscillator 18 utilizes the RC oscillation so as to periodically output a release signal 22 4 (for example: logic low) by a fixed frequency set by a user.

For convenience of description, in one embodiment, assuming that the shadowing event occurs at the solar panel corresponding to the solar cell unit 20_2. The switch 12_2 is electrically connected because of the shadowing event (that is, the first driving unit 14_1 outputs a control signal 22_1 with a logic low). The solar cell unit 20_2 is bypassed. At the same time, the release signal 22_4 outputted by the oscillator 18 is pulled up as a logic high signal through the pull high resistor in order to disable the switch 12_2 (that is, turning off the MOS) so as to release the bypass path of the solar cell unit 20_2. Therefore, the solar cell unit 20_2 can operate again.

Similarly, when the temperature sensors 24_1 and 24_2 detect that the temperature is decreased. That represents that the solar power generation module is not under a high temperature and dangerous condition or the shadowing event has been removed. Therefore, in this case, the oscillator 18 is used to electrically disconnect the switch 12_2 or 12_3 in order to release the bypass path of the solar cell 20_2 or 20_3. As a result, the power generated by the solar power generation module is maximized.

In one embodiment, as shown in FIG. 1, when the switches 12_2 and 12_3 are PMOS, the switch 12_1 can be a diode, and the diode is coupled to the last solar cell unit (for example: the solar cell unit 20_1) of the solar cell units connected in series. In another embodiment, when the switches 12_2 and 12_3 are NMOS, the switch 12_1 (the diode) is coupled to the first solar cell unit (not shown) of the solar cell units connected in series.

The present invention provides an anti-shadowing circuit of solar cell. The present invention utilizes the electric switches (for example: diode and PMOS) to determine the shadowing effect according to the voltages generated by the solar cell units and to bypass the solar cell unit encounter the shadowing effect such that the entire solar power generation module can operate normally. The present invention also provides an overheated protection unit so as to protect the electric switches from being burned because the environment temperature is too high. The present invention also provides a release unit. When the shadowing event and the overheated condition are removed, the release unit can release the solar cell unit which is bypassed before to work normally. If the release unit does not exist, and even the shadowing event is removed, the MOS switches which have been electrically connected cannot be disabled. Therefore, the power generated by the solar power generation module is maximized through the release unit of the present invention.

Through the MOS switches to execute the anti-shadowing, the power consumption of the solar power generation module is low. Besides, the power generation is large, and the overheated condition is not easy to generate. Furthermore, the MOS switches cooperate with the overheated protection unit and the oscillator to timely adjust the solar anti-shadowing circuit according to the strict climate such that the solar power generation module can work optimally.

Aforementioned descriptions only involve preferable embodiments of the present invention and therefore do not limit the protection scope of the present invention. Every equivalent variation utilizing claims of the present invention is included within the scope of patent protection of the present invention.

What is claimed is:

1. A solar anti-shadowing circuit coupled to multiple solar cell units connected in series comprising:
a metals oxide semiconductor (MOS) switching group including multiple MOS switches, and each of the MOS switches is coupled to a corresponding solar cell unit; and
a driving unit group including multiple driving units, and each of the multiple driving units respectively outputs a control signal to the corresponding MOS switch for controlling the MOS switch;
wherein, when a shadowing event is occurred, the multiple driving units output the control signals to the corresponding MOS switches so as to electrically connect the MOS switches.

2. The solar anti-shadowing circuit according to claim 1, further comprising an oscillator coupled to the switching unit group and the driving unit group through a bus to timely output a release signal, wherein, when the shadowing event is removed, the release signal outputted by the oscillator electrically disconnects the corresponding MOS switch.

3. The solar anti-shadowing circuit according to claim 2, the oscillator periodically outputs the release signal with a fixed frequency through a pull high resistor coupled to the MOS switches.

4. The solar anti-shadowing circuit according to claim 1, further comprising an overheated protection unit coupled to the switching unit group and the driving unit group through a bus; when an overheated condition is occurred, the overheated protection unit outputs an overheated signal to electrically connect the switch which is overheated.

5. The solar anti-shadowing circuit according to claim 4, wherein, the overheated protection unit includes at least one temperature sensor.

6. The solar anti-shadowing circuit according to claim 5, wherein, the temperature sensor includes a thermistor.

7. The solar anti-shadowing circuit according to claim 5, wherein, the temperature sensor includes a diode.

8. The solar anti-shadowing circuit according to claim 1, wherein, the driving unit group outputs the control signal to a gate electrode of the MOS switch to electrically connect the MOS switch in order to form a bypass path to bypass the solar cell unit which has a shadowing event.

9. The solar anti-shadowing circuit according to claim 1, wherein, the driving unit group includes an operational amplifier.

10. The solar anti-shadowing circuit according to claim 1, wherein, each of the MOS switches is a PMOS switch.

11. The solar anti-shadowing circuit according to claim 10, wherein, further comprising a diode coupled to the last solar cell unit of the solar cell units connected in series.

12. The solar anti-shadowing circuit according to claim 1, wherein, each of the MOS switches is a NMOS switch.

13. The solar anti-shadowing circuit according to claim 12, wherein, further comprising a diode coupled to the first solar cell unit of the solar cell units connected in series.
